(19) United States
(12) Patent Application Publication
(10) Pub. No.: US 2026/0343685 A1
(43) Pub. Date: Oct. 29, 2026

(54) COOKING APPARATUS

(71) Applicant: SAMSUNG ELECTRONICS CO., LTD., Suwon-si (KR)

(72) Inventors: Hyunjoon CHOO, Suwon-si (KR); Jaeyong KO, Suwon-si (KR); Sooncheol KWEON, Suwon-si (KR); Daeyoub NA, Suwon-si (KR); Heejin YOON, Suwon-si (KR); Daeun LEE, Suwon-si (KR); Haeseung LEE, Suwon-si (KR); Jungsu HA, Suwon-si (KR); Jonghun HA, Suwon-si (KR); Sangil HYUN, Suwon-si (KR); Yongseok JANG, Suwon-si (KR)

(73) Assignee: SAMSUNG ELECTRONICS CO., LTD., Suwon-si (KR)

(21) Appl. No.: 19/682,974

(22) Filed: May 20, 2026

Related U.S. Application Data
(63) Continuation of application No. PCT/KR2024/013074, filed on Aug. 30, 2024.

(30) Foreign Application Priority Data
Nov. 20, 2023 (KR) 10-2023-0161597
Mar. 12, 2024 (KR) 10-2024-0034760

(51) Int. Cl. H05B 6/06; F24C 7/08; H05B 6/12

(52) U.S. Cl. CPC H05B 6/062; F24C 7/082; H05B 6/1209; H05B 2213/05

(57) ABSTRACT

This cooking apparatus comprises: a cooking plate on which a cooking container is placed; a sensor for sensing vibration generated in the cooking container placed on the cooking plate; a metal bracket attached to the cooking plate; a sensor cover detachably mounted on the metal bracket, the sensor cover configured to press the sensor toward the cooking plate in response to the sensor cover being mounted on the metal bracket; and a fastening member to fix the sensor cover to the metal bracket.

### CROSS REFERENCE TO THE RELATED APPLICATION

This application is a continuation application, filed under 35 U.S.C. §111(a), of International Application PCT/KR2024/013074 filed on Aug. 30, 2024,, and is based on and claims priority under 35 U.S.C. §119 to Korean Patent Applications No. 10-2023-0161597, filed on Nov. 20, 2023, and Korean Patent Applications No. 10-2024-0034760, filed on Mar. 12, 2024 in the Korean Intellectual Property Office, the disclosures of which are incorporated by reference herein in their entireties.

### TECHNICAL FIELD

The present disclosure relates to a cooking apparatus including an induction heating coil.

### BACKGROUND ART

An induction heating cooking apparatus is a cooking apparatus capable of cooking food by heating a cooking container using the principle of induction heating. The induction heating cooking apparatus may be equipped with a cooking plate on which a cooking container is placed, and an induction heating coil disposed below the cooking plate and configured to generate a magnetic field when an electric current is applied.

When a current is applied to the induction heating coil and a magnetic field is generated, a secondary current is induced in the cooking container, and Joule heat is generated due to an electrical resistance component of the cooking container itself. The cooking container is heated by the Joule heat, and accordingly, food contained in the cooking container is heated.

Compared to gas ranges that heat cooking containers using the combustion heat generated by burning fossil fuels, the induction heating cooking apparatus may have a higher heat transfer rate, not generate harmful gases, and reduce the risk of fire.

The cooking apparatus may include a sensor for detecting vibrations of the cooking container that occur as food contained in the cooking container boils. Based on a fact that the sensor detects vibrations of the cooking container, the output of the cooking apparatus may be adjusted.

### DISCLOSURE

### Technical Problem

The present disclosure is directed to providing a cooking apparatus capable of improving accuracy of a sensor for detecting vibrations of a cooking container.

Additional aspects of the disclosure will be set forth in part in the description which follows and, in part, will be obvious from the description, or may be learned by practice of the disclosure.

### Technical Solution

A cooking apparatus according to an aspect of the present disclosure includes a cooking plate on which a cooking container is placed, a sensor configured to detect a vibration generated in the cooking container placed on the cooking plate, a metal bracket attached to the cooking plate, a sensor cover detachably mounted on the metal bracket, the sensor cover configured to press the sensor toward the cooking plate in response to the sensor cover being mounted on the metal bracket, and a fastening member to fix the sensor cover to the metal bracket.

The metal bracket comprises a bracket fastening portion, the sensor cover comprises a cover fastening portion, and while the bracket fastening portion and the cover fastening portion are aligned, the fastening member is screw-coupled to the bracket fastening portion and the cover fastening portion thereby fixing the sensor cover to the metal bracket.

The metal bracket further comprises a bracket coupling portion disposed on a side opposite to a side on which the bracket fastening portion is disposed, and the sensor cover comprises a cover coupling portion disposed on a side opposite to a side, on which the cover fastening portion is disposed, so as be coupled to the bracket coupling portion.

The fastening member fixes the cover fastening portion to the bracket fastening portion in a direction in which the sensor cover presses the sensor.

The metal bracket is attached to the cooking plate by an adhesive.

The metal bracket further comprises an adhesive accommodating portion spaced apart from the cooking plate to accommodate at least a portion of the adhesive in response to attaching the metal bracket to the cooking plate.

The cooking apparatus further comprises a cushioning member disposed between the sensor and the cooking plate to cushion an impact transmitted from the cooking plate to the sensor.

The cushioning member has a rectangular cross-section perpendicular to a direction from the cooking plate toward the sensor.

The cooking plate comprises: a first side on which the cooking container is placed; and a second side opposite to the first side, and on which the sensor is located.

The sensor cover comprises a material different from a material of the metal bracket.

The cooking apparatus further comprises an induction heating coil configured to heat the cooking container placed on the cooking plate; and a controller configured to control the induction heating coil based on a vibration value received from the sensor.

The controller controls an output of the induction heating coil to be lowered based on a determination that the vibration value received from the sensor is higher than a predetermined vibration value.

The sensor is spaced apart from the induction heating coil by a predetermined distance.

The metal bracket comprises a bracket cover portion configured to surround an edge of the sensor.

A cooking apparatus according to an aspect of the present disclosure includes a cooking plate on which a cooking container is placed, a sensor bracket attached to the cooking plate, a sensor configured to detect a vibration generated in the cooking container placed on the cooking plate and mountable to the sensor bracket, and a fastening member detachably coupled to the sensor bracket and configured to press the sensor toward the cooking plate in response to the fastening member being fastened to the sensor bracket.

The sensor bracket includes a guide rail configured to guide the sensor to slide along the guide rail and to be mounted on the sensor bracket.

The sensor bracket further comprises a support portion disposed at an end of the guide rail, in response to mounting the sensor on the sensor bracket, the support portion is configured to support one side of the sensor, and the fastening member, coupled to the sensor bracket supports, a side opposite to the one side of the sensor.

The fastening member includes a first fastening member configured to press a first corner of the sensor in response to the fastening member being coupled to the sensor bracket, and a second fastening member configured to press a second corner of the sensor in response to the fastening member being coupled to the sensor bracket that is different from the first corner .

The fastening member includes a pressing portion configured to press the sensor in response to the fastening member being coupled to the sensor bracket.

The cooking apparatus further includes an induction heating coil configured to heat the cooking container placed on the cooking plate, wherein the sensor is spaced apart from the induction heating coil by a predetermined distance.

### DESCRIPTION OF DRAWINGS

FIG. 1 illustrates a cooking apparatus according to an embodiment of the present disclosure.

FIG. 2 illustrates an exploded view of a partial configuration of the cooking apparatus according to an embodiment of the present disclosure.

FIG. 3 illustrates an exploded view of configurations for mounting a sensor of the cooking apparatus according to an embodiment of the present disclosure to a cooking plate.

FIG. 4 illustrates an enlarged cross-sectional view of a portion in which the sensor of the cooking apparatus according to an embodiment of the present disclosure is located.

FIG. 5 is a block diagram illustrating a configuration of the cooking apparatus according to an embodiment of the present disclosure.

FIG. 6 illustrates a state in which a sensor of a cooking apparatus according to an embodiment of the present disclosure is mounted on a cooking plate.

FIG. 7 illustrates a state in which the sensor of the cooking apparatus according to an embodiment of the present disclosure is separated from the cooking plate.

FIG. 8 illustrates a state in which a sensor of a cooking apparatus according to an embodiment of the present disclosure is mounted on a cooking plate.

FIG. 9 illustrates a state in which the sensor of the cooking apparatus according to an embodiment of the present disclosure is separated from the cooking plate.

### MODES OF THE INVENTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

Meanwhile, the terms “front,” “rear,” “left,” and “right” used in the following description are defined based on the drawings, and the shapes and positions of the respective components are not limited by these terms. For example, the Y direction in which the second region is formed is defined as the front, and the Y direction in which the first region is formed is defined as the rear, and the left, right, upper, and lower directions are defined based on these directions.

Hereinafter exemplary embodiments of the present disclosure will be described in detail with reference to the accompanying drawings.

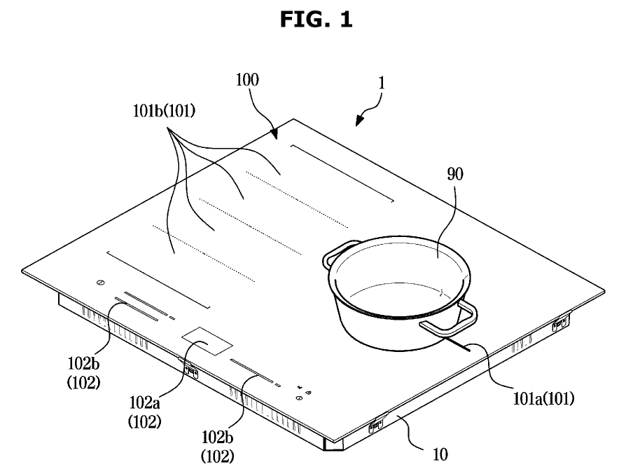

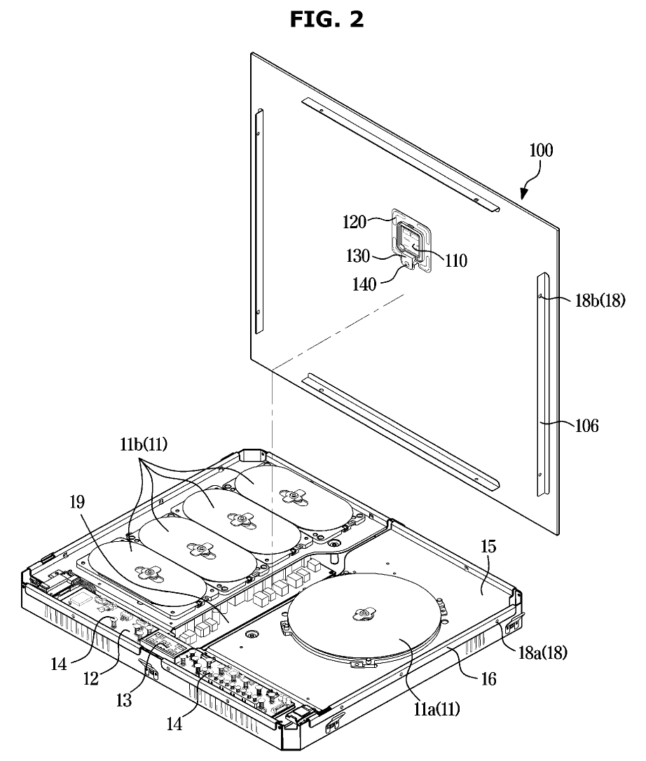

FIG. 1 illustrates a cooking apparatus according to an embodiment of the present disclosure. FIG. 2 illustrates an exploded view of a partial configuration of the cooking apparatus according to an embodiment of the present disclosure.

Referring to FIGS. 1 and 2, the cooking apparatus 1 may include a main body 10 that forms an exterior of the cooking apparatus 1 and on which various components constituting the cooking apparatus 1 are installed.

The cooking apparatus 1 may include a cooking plate 100 disposed on an upper side of the main body 10. The cooking plate 100 may have a flat shape on which a cooking container 90 may be placed. As an example, the cooking plate 100 may include ceramic glass and/or reinforced glass. For example, the cooking plate 100 may include heat-resistant glass.

The cooking plate 100 may have various materials. The cooking plate 100 may have characteristics that do not transmit light. In addition, the cooking plate 100 may have characteristic of transmitting a touch signal to transmit a signal to a circuit board 12 disposed on a lower side through touch.

An induction heating coil 11 may be accommodated inside the main body 10 and may generate a magnetic field to induce heating of the cooking container 90. The induction heating coil 11 may be electrically connected to a main board provided inside the main body 10 via a wire. The induction heating coil 11 may be located below the cooking plate 100.

For example, when a driving current is supplied to the induction heating coil 11, a magnetic field may be induced around the induction heating coil 11. Particularly, when an alternating current, which changes in magnitude and direction over time, is supplied to the induction heating coil 11, a magnetic field that changes in magnitude and direction over time may be induced around the induction heating coil 11.

The magnetic field around the induction heating coil 11 may pass through the cooking plate 100 formed of reinforced glass and may reach the cooking container 90 placed on the cooking plate 100.

Due to a magnetic field that changes in magnitude and direction over time, eddy currents rotating around the magnetic field may be generated in the cooking container 90. This phenomenon, in which eddy currents are generated due to a magnetic field that changes over time, is called electromagnetic induction. Due to the eddy currents, electrical resistance heat may be generated in the cooking container 90. Electrical resistance heat is heat generated in a resistor when a current flows through the resistor, and is also called Joule heat. The cooking container 90 is heated by this electrical resistance heat, and food contained in the cooking container 90 may be heated.

When a magnetic field passes through the metal forming the cooking container 90, an eddy current is generated by the resistance of the metal (e.g., iron) of the cooking container 90. The eddy current generated in the cooking container 90 may heat the cooking container 90 and heat the food therein.

Accordingly, the induction heating coil 11 may heat the cooking container 90 using electromagnetic induction and electric resistance heat.

The cooking container 90 may include a pot, frying pan, steamer, rice cooker, etc. The types of cooking containers 90 are not limited thereto. In this example, a pot will be used as an example.

For example, the induction heating coil 11 may include a first induction heating coil 11a and a second induction heating coil 11b having a different size and/or shape from the first induction heating coil 11. For example, the first induction heating coil 11 may have a different output from the second induction heating coil 11b. For example, a plurality of second induction heating coils 11b may be provided.

The cooking plate 100 may include a cooking zone 101 corresponding to the induction heating coil 11. The cooking container 90 may be placed in the cooking zone 101. The cooking zone 101 may be formed on an upper surface of the cooking plate 100. The number and location of the cooking zone 101 are not limited thereto.

For example, the cooking zone 101 may include a first cooking zone 101a corresponding to the first induction heating coil 11a, and a second cooking zone 101b corresponding to the second induction heating coil 11b. As an example, the second cooking zone 101b may include a region in which the plurality of second induction heating coils 11b is provided. The cooking apparatus 1 may uniformly heat the cooking container 90 regardless of where the cooking container 90 is located in the second cooking zone 101b.

A user interface 102 receiving control commands from a user and displaying operation information of the cooking apparatus 1 to the user may be provided on one side of the cooking plate 100. However, the location of the user interface 102 is not limited to the cooking plate 100 and may be provided at various locations, such as front and/or side surface of the main body 10. The user interface 102 may include a displaying portion 102a and an inputter 102b.

The circuit board 12 may be disposed under the cooking plate 100. The circuit board 12 may include a display 13 and a touch portion 14. The circuit board 12 may include a printed board assembly (PBA) including a display, a switch element, an integrated circuit element, etc., for implementing the user interface 102, and a printed circuit board (PCB) on which the display, the switch elements, the integrated circuit element, etc. are installed.

The display 13 may be positioned to correspond to the display portion 102a of the cooking plate 100. The display 13 may indicate whether the cooking container 90 is being heated by the induction heating coil 11. Thus, a user can check whether the cooking container 90 is being heated through the display portion 102a.

The touch portion 14 may be positioned to correspond to the inputter 102b of the cooking plate 100. The touch portion 14 may receive a touch signal from the inputter 102b. For example, the touch portion 14 may receive input using a capacitive touch method. However, it is not limited thereto, and the touch portion 14 may also receive input using a pressure-sensitive touch method. A user can control the current flowing through the induction heating coil 11 through the inputter 102b, and determine an extent to which the cooking container 90 is heated.

The induction heating coil 11 may be mounted on a coil mounting plate 15. The coil mounting plate 15 may be equipped with a coil mounting hole for mounting the induction heating coil 11. A plurality of coil mounting holes may be provided.

Below the induction heating coil 11, a printed circuit board assembly 19 may be provided to implement a circuit for supplying a driving current to the induction heating coil 11. The printed circuit board assembly 19 may include a switch element, an integrated circuit element, etc. for supplying a driving current, and a printed circuit board on which the switch element, the integrated circuit element, etc. are installed.

For example, the printed circuit board assembly 19 may include a sub-assembly equipped with a sensing circuit configured to detect whether the cooking container 90 is present and configured to detect a temperature of the cooking container 90, a driving assembly equipped with a driving circuit configured to supply a driving current to the induction heating coil 11, and/or a power assembly equipped with a power circuit configured to supply power to the driving circuit.

The main body 10 may include a first frame 16 provided to support the cooking plate 100. The first frame 16 may be provided to support the cooking plate 100 on an upper side thereof. The first frame 16 may be formed by extending upward from four ends of the coil mounting plate 15. The first frame 16 may be provided to allow the cooking plate 100 to be mounted and supported on the main body 10.

A fastening hole 18 for fastening with a second frame 106 provided on the cooking plate 100 may be formed in the first frame 16. The fastening hole 18 formed in the first frame 16 may be referred to as a first fastening hole 18a.

The second frame 106 may be provided on the cooking plate 100. The cooking plate 100 is provided to be supported on the first frame 16 of the main body 10. The second frame 106 corresponding to the first frame 16 may be provided on a lower surface of the cooking plate 100.

The second frame 106 is provided to be in contact with the first frame 16 of the main body 10. The second frame 106 may be provided to allow the cooking plate 100 to be mounted on the main body 10. The second frame 106 may be provided on an outer edge of the lower surface of the cooking plate 100. The second frame 106 may be fixed to the lower surface of the cooking plate 100. The second frame 106 may be attached to the outer edge of the lower surface of the cooking plate 100 through heat-resistant silicone. A plurality of second frames 106 may be provided. The second frame 106 may be positioned on both lateral sides and the rear side of the cooking plate 100.

The second frame 106 may be provided to correspond to the first frame 16. The fastening hole 18 for fastening with the first frame 16 of the main body 10 may be formed in the second frame 106. The fastening hole 18 formed in the second frame 106 is referred to as a second fastening hole 18b. The second fastening hole 18b may be formed at a position corresponding to the first fastening hole 18a. The second fastening hole 18b may be formed in multiple numbers on both lateral sides and the rear side of the second frame 106.

The cooking plate 100 may be mounted on an upper portion of the main body 10 by coupling the second frame 106, which is fixed to the lower portion of the cooking plate 100, with the first frame 16 of the main body 10.

The cooking apparatus 1 may include a sensor 110 for detecting vibrations of the cooking plate 100. The cooking plate 100 may include a first side for the cooking container 90 to be placed on, and a second side where the sensor 110 is located. The second side may be opposite to the first side. For example, the first side may face upward, and the second side may face downward.

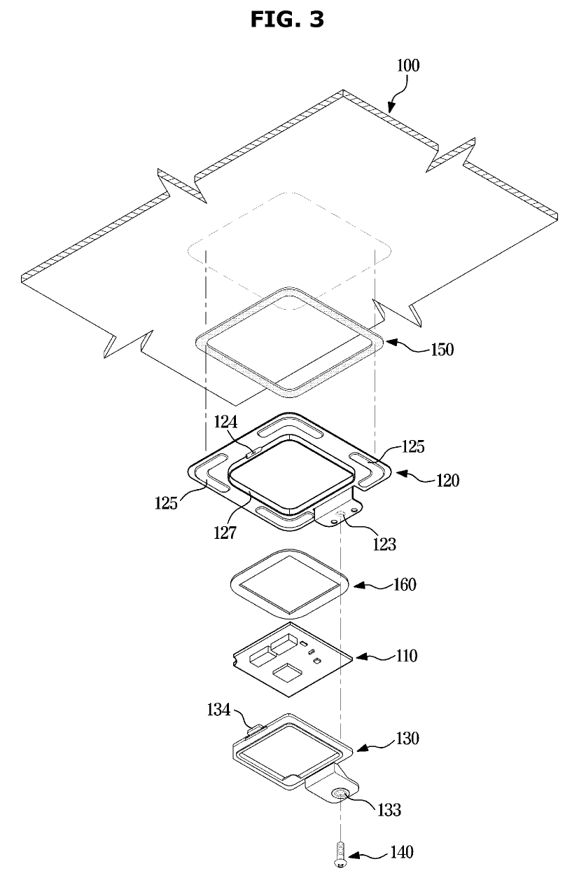

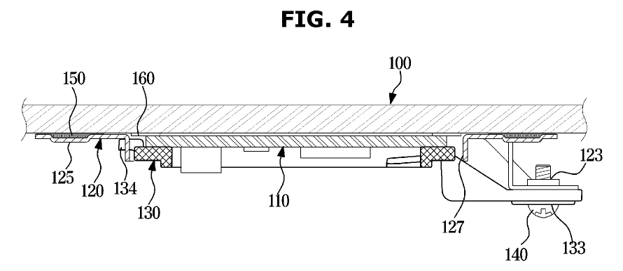

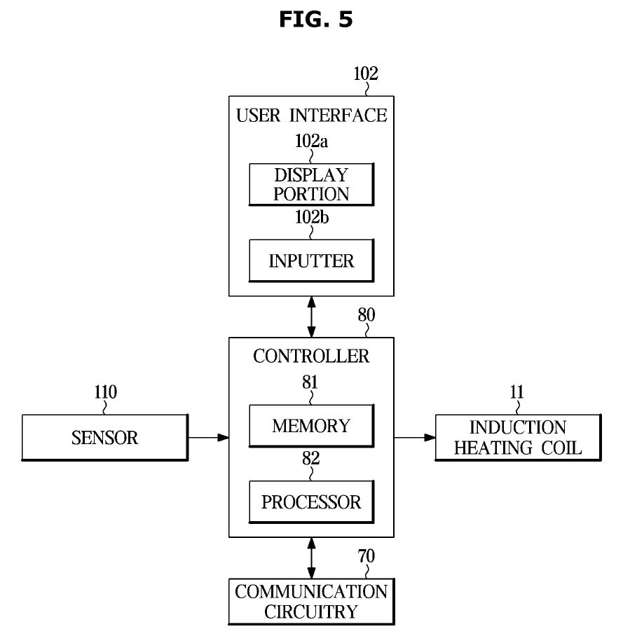

FIG. 3 illustrates an exploded view of configurations for mounting a sensor of the cooking apparatus according to an embodiment of the present disclosure to a cooking plate. FIG. 4 illustrates an enlarged cross-sectional view of a portion in which the sensor of the cooking apparatus according to an embodiment of the present disclosure is located. FIG. 5 is a block diagram illustrating a configuration of the cooking apparatus according to an embodiment of the present disclosure.

Referring to FIGS. 2-4, the cooking apparatus 1 according to one embodiment of the present disclosure may include the sensor 110 for detecting vibrations of the cooking container 90 placed on the cooking plate 100. The sensor 110 may detect vibrations of the cooking container 90 that occur as food contained in the cooking container 90 boils. Vibrations of the cooking container 90 may be transmitted to the cooking plate 100, and the sensor 110 may detect the vibrations transmitted to the cooking plate 100.

When the food in the cooking container 90 placed on the cooking plate 100 is heated, a flow of the food may occur. This flow of food may cause physical effects on the cooking container 90 and generate vibrations. The vibrations of the cooking container 90 may be transmitted to the cooking plate 100 on which the cooking container 90 is placed. The sensor 110 may detect a vibration pattern of the cooking container 90 through the cooking plate 100 by detecting the vibration of the cooking plate 100. Therefore, by analyzing the vibration pattern of the cooking container 90 that occurs during a boiling process of the food, it is possible to determine whether the food contained in the cooking container 90 is boiling.

For example, the sensor 110 may be a 1-axis accelerometer configured to detect any one of X-axis acceleration, Y-axis acceleration, or Z-axis acceleration of the cooking container 90. For example, the sensor 110 may be a 2-axis accelerometer configured to detect two of the X-axis acceleration, Y-axis acceleration, or Z-axis acceleration of the cooking container 90. For example, the sensor 110 may be a 3-axis accelerometer or a 3-axis Micro Electro Mechanical System (MEMS) sensor configured to detect all of the X-axis acceleration, Y-axis acceleration, and Z-axis acceleration of the cooking container 90.

The sensor 110 may collect sensor data regarding the vibration of the cooking container 90. For example, the sensor 110 may obtain an acceleration of an axis corresponding to the vibration of the cooking container 90.

The sensor 110 may be positioned to be spaced apart from the induction heating coil 11 by a predetermined distance. As the sensor 110 is positioned to be spaced apart from the induction heating coil 11 by a predetermined distance, damage to the sensor 110 by heat generated from the induction heating coil 11 may be prevented.

The sensor 110 may be disposed between the first cooking zone 101a and the second cooking zone 101b to detect vibrations generated from a cooking container placed in the first cooking zone 101a and vibrations generated from a cooking container placed in the second cooking zone 101b.

The cooking apparatus 1 may include a metal bracket 120 attached to the cooking plate 100. The metal bracket 120 may be formed by including metal. The metal bracket 120 may be attached to the cooking plate 100 by an adhesive 150. For example, the adhesive 150 may include silicone adhesive or double-sided tape.

The metal bracket 120 may include an adhesive accommodating portion 125 for accommodating at least a portion of the adhesive 150 when attached to the cooking plate 100. The adhesive accommodating portion 125 may be formed to be spaced apart from the cooking plate 100 when the metal bracket 120 is attached to the cooking plate 100. When the metal bracket 120 is attached to the cooking plate 100, a space may be formed between the adhesive accommodating portion 125 and the cooking plate 100. The adhesive 150 may be filled into the space formed between the adhesive accommodating portion 125 and the cooking plate 100.

The metal bracket 120 may form a space for accommodating the sensor 110. The metal bracket 120 may include a bracket cover portion 127 provided to surround an edge of the sensor 110. The bracket cover portion 127 may extend along the edge of the sensor 110. The sensor 110 may be located in the space formed by the metal bracket 120.

The cooking apparatus 1 may include a sensor cover 130 detachably mounted on the metal bracket 120. The sensor cover 130 may be provided to press the sensor 110 toward the cooking plate 100 when mounted on the metal bracket 120. For example, the sensor cover 130 may include a material different from that of the metal bracket 120. For example, the sensor cover 130 may include a material that is more flexible than that of the metal bracket 120.

The cooking apparatus 1 may include a fastening member 140 for fixing the sensor cover 130 to the metal bracket 120. For example, the fastening member 140 may include a screw.

The metal bracket 120 may include a bracket fastening portion 123. The bracket fastening portion 123 may protrude from one edge of the metal bracket 120. For example, the bracket fastening portion 123 may include a hole including screw threads to allow the fastening member 140 to be screw-coupled.

The sensor cover 130 may include a cover fastening portion 133. The cover fastening portion 133 may protrude from one edge of the sensor cover 130. For example, the cover fastening portion 133 may include a hole including screw threads to allow the fastening member 140 to be screw-coupled.

When the bracket fastening portion 123 and the cover fastening portion 133 are aligned, the fastening member 140 may be screw-coupled to the bracket fastening portion 123 and the cover fastening portion 133. As the fastening member 140 is screw-coupled to the bracket fastening portion 123 and the cover fastening portion 133, the sensor cover 130 may be mounted and fixed to the metal bracket 120.

The metal bracket 120 may include a bracket coupling portion 124 provided on one side opposite to one side where the bracket fastening portion 123 is provided. The sensor cover 130 may include a cover coupling portion 134 provided on one side opposite to one side, on which the cover fastening portion 133 is provided, so as to be coupled to the bracket coupling portion 124.

For example, the bracket coupling portion 124 may have a groove or hole shape, and the cover coupling portion 134 may have a hook or protrusion shape insertable into the bracket coupling portion 124, but is not limited thereto. However, the shapes of the bracket coupling portion 124 and the cover coupling portion 134 may be arranged in the opposite way to those described above.

In order to couple the sensor cover 130 to the metal bracket 120, after aligning the bracket fastening portion 123 and the cover fastening portion 133 in a state in which the cover coupling portion 134 is coupled to the bracket coupling portion 124, the fastening member 140 may be fastened to the bracket fastening portion 123 and the cover fastening portion 133. As for the metal bracket 120 and the sensor cover 130, one side thereof may be mutually fixed by the coupling of the cover coupling portion 134 and the bracket coupling portion 124, and the other side thereof may be mutually fixed as the fastening member 140 is coupled to the bracket fastening portion 123 and the cover fastening portion 133.

The fastening member 140 may be provided to be screw-coupled to the bracket fastening portion 123 and the cover fastening portion 133 in a direction in which the sensor cover 130 presses the sensor 110 toward the cooking plate 100. As the fastening member 140 is coupled to the bracket fastening portion 123 and the cover fastening portion 133 in the direction in which the sensor cover 130 presses the sensor 110 toward the cooking plate 100, a degree of contact between the sensor 110 and the cooking plate 100 may be improved.

The cooking apparatus 1 may include a cushioning member 160 to cushion an impact transmitted from the cooking plate 100 to the sensor 110. The cushioning member 160 may be disposed between the sensor 110 and the cooking plate 100. For example, the cushioning member 160 may include a material that is more flexible than the cooking plate 100.

For example, the cushioning member 160 may be provided with a rectangular cross-section perpendicular to a direction from the cooking plate 100 toward the sensor 110. The cushioning member 160 may have a rectangular cross-section perpendicular to the up and down direction. An upper surface of the cushioning member 160 may be in contact with the cooking plate 100, and a lower surface of the cushioning member 160 may be in contact with the sensor 110. The cushioning member 160 may extend along the edge of the sensor 110.

In the cooking apparatus 1 according to one embodiment of the present disclosure, as the fastening member 140 presses the sensor cover 130, the sensor 110 may be in close contact with the cooking plate 100 and thus a detection performance of vibration of the cooking container 90 transmitted through the cooking plate 100 may be improved. In the cooking apparatus 1 according to one embodiment of the present disclosure, the degree of contact between the sensor 110 and the cooking plate 100 may be improved, and thus the vibration detection performance of the sensor 110 may be improved.

Referring to FIG. 5, the cooking apparatus 1 includes the user interface 102, the sensor 110, the induction heating coil 11, a controller 80, and a communication circuitry 70.

The induction heating coil 11 may generate a magnetic field and/or an electromagnetic field to heat the cooking container 90.

The user interface 102 may include the displaying portion 102a receiving touch input from a user and displaying an image regarding the operation of the cooking apparatus 1 in response to the user's touch input, and the inputter 102b receiving control commands from a user.

For example, the displaying portion 102a may include a touch panel receiving touch input from a user, a display panel displaying an image regarding the operation of the cooking apparatus 1, and a touch screen controller configured to control the operation of the touch panel and the display panel.

The displaying portion 102a may display an image regarding the operation of the cooking apparatus 1 and output a user's touch input to the controller 80. In addition, the displaying portion 102a may receive information regarding the operation of the cooking apparatus 1 from the controller 80 and display an image corresponding to the received information.

The inputter 102b may include a plurality of buttons provided to receive a predetermined control command from a user and output an electrical signal corresponding to the user's control command to the controller 80. For example, the inputter 102b may include an operation button provided to receive a power on/off command of the cooking apparatus 1, a power up button and a power down button provided to receive the magnitude of the magnetic field and/or electromagnetic field output by the cooking apparatus 1.

The inputter 102b may be implemented with various types of buttons (or switches), such as a push button, a slide button, a toggle button, a touch button, or a dial.

As mentioned above, the user interface 102 may receive a control command from a user and output an electrical signal corresponding to the user's control command to the controller 80. Additionally, the user interface 102 may receive information regarding the operation of the cooking apparatus 1 from the controller 80 and display an image corresponding to the information regarding the operation of the cooking apparatus 1.

The sensor 110 may detect vibrations of the cooking container 90 placed on the cooking plate 100. The sensor 110 may detect vibrations of the cooking container 90 that occur as food contained in the cooking container 90 boils. Vibrations of the cooking container 90 may be transmitted to the cooking plate 100, and the sensor 110 may detect the vibrations transmitted to the cooking plate 100.

The controller 80 may include at least one memory 81 in which a program for performing the operation is stored, and at least one processor 82 configured to execute the stored program.

The at least one processor 82 may include a microprocessor. The microprocessor is a processing unit in which an arithmetic logic unit, a register, a program counter, an instruction decoder, or a control circuit, etc. are provided on at least one silicon chip.

The microprocessor may include a Graphic Processing Unit (GPU) for graphic processing of images or videos. The microprocessor may be implemented in the form of a System On Chip (SoC) that includes a core and a GPU. The microprocessor may include a single core, dual core, triple core, quad core, and multiples thereof.

Further, the at least one processor 82 may include an input/output processor that mediates data entry and exit between various components included in the cooking apparatus 1 and the controller 80.

The at least one memory 81 may include non-volatile memory such as ROM, high-speed random access memory (RAM), magnetic disk storage device, flash memory device, or other types of non-volatile semiconductor memory devices.

For example, the at least one memory 81 may include one of a Secure Digital (SD) memory card, Secure Digital High Capacity (SDHC) memory card, mini SD memory card, mini SDHC memory card, Trans Flach (TF) memory card, micro SD memory card, micro SDHC memory card, Memory Stick, Compact Flach (CF), Multi-Media Card (MMC), MMC micro, or eXtreme Digital (XD) card as a semiconductor memory device.

Additionally, the at least one memory 81 may include a network-attached storage device that is accessed via a network.

The controller 80 may control the induction heating coil 11 based on a vibration value received from the sensor 110. For example, the controller 80 may control the output of the induction heating coil 11 to be lowered based on a determination that the vibration value received from the sensor 110 is higher than a predetermined vibration value. The controller 80 may determine that the food inside the cooking container 90 is boiling based on the determination that the vibration value received from the sensor 110 is higher than the predetermined vibration value.

The communication circuitry 70 may include at least one of a short-wireless range communication module or a long-range wireless communication module.

The communication circuitry 70 may transmit data to an external device or receive data from an external device. For example, the communication circuitry 70 may establish communication with a server, a user device and/or other home appliances and transmit and receive various data.

For the communication, the communication circuitry 70 may support the establishment of a direct (e.g., wired) communication channel or a wireless communication channel between external devices, and the performance of communication through the established communication channel. According to one embodiment, the communication circuitry 70 may include a wireless communication module (e.g., a cellular communication module, a short-range wireless communication module, or a global navigation satellite system (GNSS) communication module) or a wired communication module (e.g., a local area network (LAN) communication module, or a power line communication module). The corresponding communication module among these communication modules may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., a LAN or WAN)). These various types of communication modules may be integrated into a single component (e.g., a single chip) or implemented as multiple separate components (e.g., multiple chips).

The short-range wireless communication module may include Bluetooth communication modules, Bluetooth Low Energy (BLE) communication modules, Near Field Communication modules, WLAN (Wi-Fi) communication modules, Zigbee communication modules, infrared Data Association (IrDA,) communication modules, Wi-Fi Direct (WFD) communication modules, ultrawideband (UWB) communication modules, Ant+ communication modules, microwave (uWave) communication modules, etc., but is not limited thereto.

The long-range communication module may include a communication module that performs various types of long-distance communication and may include a mobile communication circuitry. The mobile communication circuitry transmits and receives wireless signals with at least one of a base station, an external terminal, and a server on a mobile communication network.

In one embodiment, the communication circuitry 70 may communicate with external devices such as a server, user device, and other home appliances through a nearby access point (AP). The access point (AP) may connect a local area network (LAN), to which the cooking apparatus 1, other home appliances, and/or user device are connected, to a wide area network (WAN) to which the server is connected. The cooking apparatus 1, other home appliances, and/or user device may be connected to the server through the wide area network (WAN).

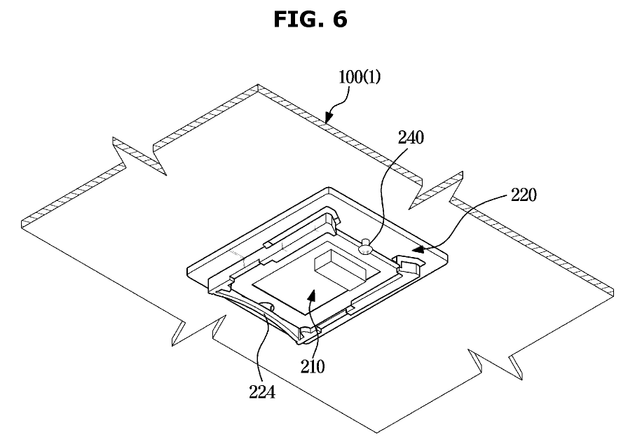

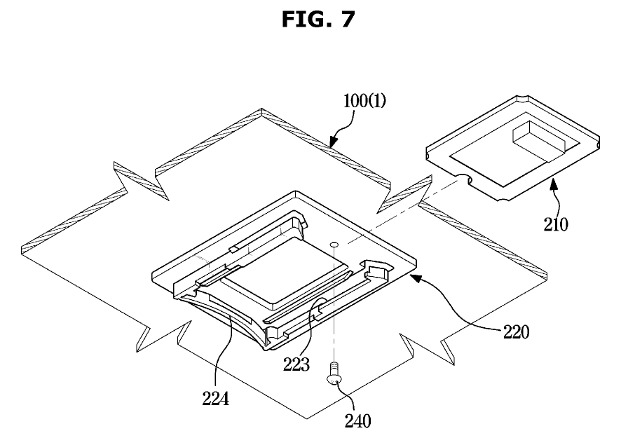

FIG. 6 illustrates a state in which a sensor of a cooking apparatus according to an embodiment of the present disclosure is mounted on a cooking plate. FIG. 7 illustrates a state in which the sensor of the cooking apparatus according to an embodiment of the present disclosure is separated from the cooking plate.

Referring to FIGS. 6 and 7, a cooking apparatus 1 according to one embodiment of the present disclosure may include a sensor bracket 220 attached to a cooking plate 100, and a sensor 210 detachably mounted on the sensor bracket 220.

The sensor 210 may detect vibrations generated from a cooking container 90 placed on the cooking plate 100. The sensor 210 may detect vibrations of the cooking container 90 generated as food contained in the cooking container 90 boils. Vibrations of the cooking container 90 may be transmitted to the cooking plate 100, and the sensor 210 may detect the vibrations transmitted to the cooking plate 100.

The sensor bracket 220 may be attached to the cooking plate 100 by an adhesive. For example, the sensor bracket 220 may include metal. The sensor bracket 220 may support the sensor 210 when the sensor 210 is mounted.

The sensor bracket 220 may include a guide rail 223. The guide rail 223 may be provided to allow the sensor 210 to be mounted thereon. The sensor 210 may slide along the guide rail 223 and be mounted on the sensor bracket 220. The guide rail 223 may support the sensor 210 when the sensor 210 is mounted on the sensor bracket 220.

The sensor bracket 220 may include a support portion 224. The support portion 224 may be provided at one end of the guide rail 223. When the sensor 210 is mounted on the sensor bracket 220, the support portion 224 may support one side of the sensor 210.

The cooking apparatus 1 may include a fastening member 240. The fastening member 240 may be detachably coupled to the sensor bracket 220. When the fastening member 240 is fastened to the sensor bracket 220, the fastening member 240 may be provided to press the sensor 210 toward the cooking plate 100. When the sensor 210 is mounted on the sensor bracket 220, the fastening member 240 may support one side that is opposite to one side supported by the support portion 224 of the sensor 210. The fastening member 240 may support the sensor 210 to prevent shaking of the sensor 210 mounted on the sensor bracket 220. The fastening member 240 may be omitted.

The sensor 210 according to one embodiment of the present disclosure may be detachably mounted on the sensor bracket 220, and thus it is possible to make maintenance and/or repair easier.

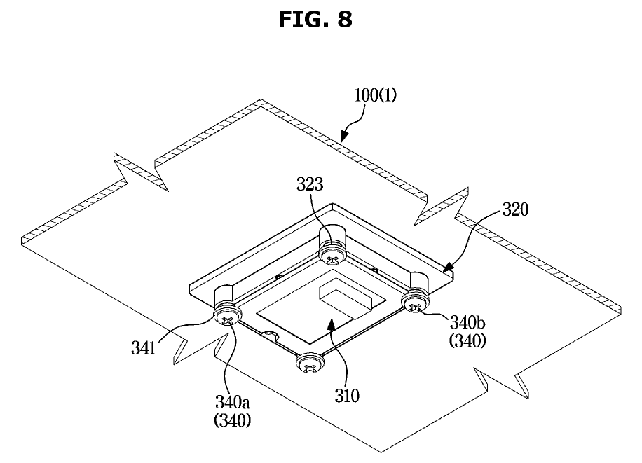

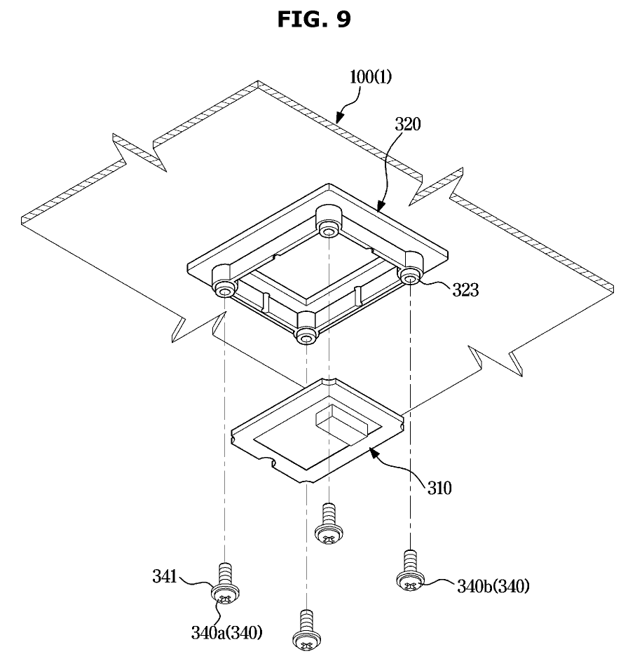

FIG. 8 illustrates a state in which a sensor of a cooking apparatus according to an embodiment of the present disclosure is mounted on a cooking plate. FIG. 9 illustrates a state in which the sensor of the cooking apparatus according to an embodiment of the present disclosure is separated from the cooking plate.

Referring to FIGS. 8 and 9, a cooking apparatus 1 according to one embodiment of the present disclosure may include a sensor bracket 320 attached to a cooking plate 100, and a sensor 310 detachably mounted on the sensor bracket 320.

The sensor 310 may detect vibrations generated from a cooking container 90 placed on the cooking plate 100. The sensor 310 may detect vibrations of the cooking container 90 generated as food contained in the cooking container 90 boils. Vibrations of the cooking container 90 may be transmitted to the cooking plate 100, and the sensor 310 may detect the vibrations transmitted to the cooking plate 100.

The sensor bracket 320 may be attached to the cooking plate 100 by an adhesive. For example, the sensor bracket 320 may include metal. The sensor bracket 320 may support the sensor 310 when the sensor 310 is mounted.

The sensor bracket 320 may include a bracket fastening portion 323. The bracket fastening portion 323 may have a groove or hole shape including screw threads to allow the fastening member 340 to be screw-coupled. The bracket fastening portion 323 may be provided to correspond to corners of the sensor 310. For example, in response to the sensor 310 having a quadrangle shape, the bracket fastening portion 323 may be provided to correspond to four corners of the sensor 310.

The cooking apparatus 1 may include a fastening member 340. The fastening member 340 may be detachably coupled to a sensor bracket 320. When the fastening member 340 is fastened to the sensor bracket 320, the fastening member 340 may be provided to press the sensor 310 toward the cooking plate 100. The sensor 310 may include a groove-shaped guide at the corner for the fastening member 340.

When the sensor 310 is mounted on the sensor bracket 320, the fastening member 340 may include a pressing portion 341 for pressing the sensor 310 toward the cooking plate 100. For example, the pressing portion 341 may be provided at one end of the fastening member 340. The pressing portion 341 may be provided to have a larger cross-sectional area compared to other portion of the fastening member 340.

The fastening member 340 may be provided to correspond to corners of the sensor 310. For example, the fastening member 340 may include a first fastening member 340a provided to press a first corner of the sensor 310, and a second fastening member 340b provided to press a second corner different from the first corner of the sensor 310. For example, in response to the sensor 310 having a quadrangle shape, the fastening member 340 may be provided to correspond to four corners.

The sensor 310 according to one embodiment of the present disclosure may be detachably mounted on the sensor bracket 320, and thus it is possible to make maintenance and/or repair easier.

A cooking apparatus 1 according to an embodiment includes a cooking plate 100 on which a cooking container 90 is placed, a sensor 110 configured to detect a vibration generated in the cooking container placed on the cooking plate, a metal bracket 120 attached to the cooking plate, a sensor cover 130 detachably mounted on the metal bracket, the sensor cover configured to press the sensor toward the cooking plate in response to the sensor cover being mounted on the metal bracket, and a fastening member 140 to fix the sensor cover to the metal bracket.

The metal bracket may include a bracket fastening portion 123. The sensor cover may include a cover fastening portion 133. While the bracket fastening portion and the cover fastening portion are aligned, the fastening member may be screw-coupled to the bracket fastening portion and the cover fastening portion thereby fixing the sensor cover to the metal bracket.

The metal bracket may further include a bracket coupling portion 124 disposed on a side opposite to a side on which the bracket fastening portion is disposed. The sensor cover may include a cover coupling portion 134 disposed on a side opposite to a side, on which the cover fastening portion is disposed, so as be coupled to the bracket coupling portion.

The fastening member may fix the cover fastening portion to the bracket fastening portion in a direction in which the sensor cover presses the sensor.

The metal bracket may be attached to the cooking plate by an adhesive 150.

The metal bracket may further include an adhesive accommodating portion 125 spaced apart from the cooking plate to accommodate at least a portion of the adhesive in response to attaching the metal bracket to the cooking plate.

The cooking apparatus may further include a cushioning member 160 disposed between the sensor and the cooking plate to cushion an impact transmitted from the cooking plate to the sensor.

The cushioning member may have a rectangular cross-section perpendicular to a direction from the cooking plate toward the sensor.

The cooking plate may include a first side on which the cooking container is placed, and a second side opposite to the first side, and on which the sensor is located.

The sensor cover may include a material different from a material of the metal bracket.

The cooking apparatus may further include an induction heating coil 11 configured to heat the cooking container placed on the cooking plate, and a controller 80 configured to control the induction heating coil based on a vibration value received from the sensor.

The controller may control an output of the induction heating coil to be lowered based on a determination that the vibration value received from the sensor is higher than a predetermined vibration value.

The sensor may be spaced apart from the induction heating coil by a predetermined distance.

The metal bracket may include a bracket cover portion 127 configured to surround an edge of the sensor.

A cooking apparatus 1 according to an embodiment includes a cooking plate 100 on which a cooking container 90 is placed, a sensor bracket 220 or 230 attached to the cooking plate, a sensor 210 or 310 configured to detect a vibration generated in the cooking container placed on the cooking plate, the sensor mountable to the sensor bracket, and a fastening member 240 or 340 detachably coupled to the sensor bracket, and configured to press the sensor toward the cooking plate in response to the fastening member being fastened to the sensor bracket.

The sensor bracket may include a guide rail 223 configured to guide the sensor to slide along the guide rail and to be mounted on the sensor bracket.

The sensor bracket may further include a support portion disposed at an end of the guide rail. In response to mounting the sensor on the sensor bracket, the support portion 224 may be configured to support one side of the sensor, and the fastening member, coupled to the sensor bracket supports, a side opposite to the one side of the sensor.

The fastening member may include a first fastening member 340a configured to press a first corner of the sensor in response to the fastening member being coupled to the sensor bracket, and a second fastening member 340b configured to press a second corner of the sensor in response to the fastening member being coupled to the sensor bracket that is different from the first corner.

The fastening member may include a pressing portion 341 configured to press the sensor in response to the fastening member being coupled to the sensor bracket.

The cooking apparatus may further include an induction heating coil 11 configured to heat a cooking container placed on the cooking plate. The sensor may be spaced apart from the induction heating coil by a predetermined distance.

As is apparent from the above description, a cooking apparatus may allow a sensor for detecting vibrations of a cooking container to be in close contact with a cooking plate, thereby improving accuracy of a sensor.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

What is claimed is:

1. A cooking apparatus comprising:
a cooking plate on which a cooking container is placed;
a sensor configured to detect a vibration generated in the cooking container placed on the cooking plate;
a metal bracket attached to the cooking plate;
a sensor cover detachably mounted on the metal bracket, the sensor cover configured to press the sensor toward the cooking plate in response to the sensor cover being mounted on the metal bracket; and
a fastening member to fix the sensor cover to the metal bracket.

2. The cooking apparatus of claim 1, wherein:
the metal bracket comprises a bracket fastening portion;
the sensor cover comprises a cover fastening portion; and
wherein while the bracket fastening portion and the cover fastening portion are aligned, the fastening member is screw-coupled to the bracket fastening portion and the cover fastening portion thereby fixing the sensor cover to the metal bracket.

3. The cooking apparatus of claim 2, wherein
the metal bracket further comprises a bracket coupling portion disposed on a side opposite to a side on which the bracket fastening portion is disposed, and
wherein the sensor cover comprises a cover coupling portion disposed on a side opposite to a side, on which the cover fastening portion is disposed, so as be coupled to the bracket coupling portion.

4. The cooking apparatus of claim 2, wherein
the fastening member fixes the cover fastening portion to the bracket fastening portion in a direction in which the sensor cover presses the sensor.

5. The cooking apparatus of claim 1, wherein
the metal bracket is attached to the cooking plate by an adhesive.

6. The cooking apparatus of claim 5, wherein
the metal bracket further comprises an adhesive accommodating portion spaced apart from the cooking plate to accommodate at least a portion of the adhesive in response to attaching the metal bracket to the cooking plate.

7. The cooking apparatus of claim 1, further comprising:
a cushioning member disposed between the sensor and the cooking plate to cushion an impact transmitted from the cooking plate to the sensor.

8. The cooking apparatus of claim 7, wherein
the cushioning member has a rectangular cross-section perpendicular to a direction from the cooking plate toward the sensor.

9. The cooking apparatus of claim 1, wherein
the cooking plate comprises:
a first side on which the cooking container is placed; and
a second side opposite to the first side, and on which the sensor is located.

10. The cooking apparatus of claim 1, wherein
the sensor cover comprises a material different from a material of the metal bracket.

11. The cooking apparatus of claim 1, further comprising:
an induction heating coil configured to heat the cooking container placed on the cooking plate; and
a controller configured to control the induction heating coil based on a vibration value received from the sensor.

12. The cooking apparatus of claim 11, wherein
the controller controls an output of the induction heating coil to be lowered based on a determination that the vibration value received from the sensor is higher than a predetermined vibration value.

13. The cooking apparatus of claim 11, wherein
the sensor is spaced apart from the induction heating coil by a predetermined distance.

14. The cooking apparatus of claim 1, wherein
the metal bracket comprises a bracket cover portion configured to surround an edge of the sensor.

15. A cooking apparatus including:
a cooking plate on which a cooking container is placed;
a sensor bracket attached to the cooking plate;
a sensor configured to detect a vibration generated in the cooking container placed
on the cooking plate, the sensor mountable to the sensor bracket; and
a fastening member detachably coupled to the sensor bracket, and configured to
press the sensor toward the cooking plate in response to the fastening member being fastened to the sensor bracket.

16. The cooking apparatus of claim 15, wherein the sensor bracket includes a guide rail
configured to guide the sensor to slide along the guide rail and to be mounted on the sensor bracket.

17. The cooking apparatus of claim 15, wherein:
the sensor bracket further comprises a support portion disposed at an end of the guide
rail;
in response to mounting the sensor on the sensor bracket, the support portion is configured to support one side of the sensor; and
the fastening member, coupled to the sensor bracket supports, a side opposite to the one side of the sensor.

18. The cooking apparatus of claim 15, wherein the fastening member includes:
a first fastening member configured to press a first corner of the sensor
in response to the fastening member being coupled to the sensor bracket; and
a second fastening member configured to press a second corner of the sensor in response to the fastening member being coupled to the sensor bracket that is different from the first corner .

19. The cooking apparatus of claim 15, wherein the fastening member includes a
pressing portion configured to press the sensor in response to the fastening member being coupled to the sensor bracket.

20. The cooking apparatus of claim 15, further including an induction heating coil
configured to heat the cooking container placed on the cooking plate, wherein the sensor is spaced apart from the induction heating coil by a predetermined distance.
